(19) United States
(12) Patent Application Publication
(10) Pub. No.: US 2007/0251685 A1
(43) Pub. Date: Nov. 1, 2007

(54) TEMPERATURE CONTROL SYSTEM AND METHOD FOR OPERATING THE SAME

(75) Inventor: Herman H. Viegas, Bloomington, MN (US)

Correspondence Address: MICHAEL BEST & FRIEDRICH LLP, 100 E WISCONSIN AVENUE, Suite 3300, MILWAUKEE, WI, 53202, US

(73) Assignee: THERMO KING CORPORATION, Minneapolis, MN (US)

(21) Appl. No.: 11/741,955

(22) Filed: Apr. 30, 2007

Related U.S. Application Data
(60) Provisional application No. 60/796,394, filed on May 1, 2006.

(51) Int. Cl. B60H 3/00; B60H 1/00; B60H 1/32

(52) U.S. Cl. 165/202; 62/239; 165/42; 165/43

(57) ABSTRACT

A temperature-controlled vehicle includes a driving portion including an engine powering the vehicle for movement. The temperature-controlled vehicle further includes a cargo portion including a load space, a heat exchanger in communication with the load space, a cryogen refrigeration circuit in communication with the heat exchanger, a fossil fuel heater selectively providing heat to the load space, a control system interactively coupled with the cryogen refrigeration circuit and the fossil fuel heater to control the temperature within the load space, and an electrical power supply disposed on the cargo portion and coupled to the fossil fuel heater and the control system to selectively provide electrical power thereto.

### CROSS-REFERENCE TO RELATED APPLICATIONS

This application claims priority to Provisional Patent Application Ser. No. 60/796,394 filed on May 1, 2006 entitled “TEMPERATURE CONTROL SYSTEM AND METHOD FOR OPERATING THE SAME”, the entire contents of which is hereby incorporated by reference.

### FIELD OF THE INVENTION

The present invention relates to temperature control systems, and more particularly to transport temperature control systems and methods of operating the same.

### SUMMARY

Some embodiments of the invention provide a temperature control system for conditioning air in a load space. The temperature control system can be operated in a refrigeration mode, a heating mode, and a defrost mode. The temperature control system can include a heat exchanger having an evaporator coil and a heating coil. Fans can be supported in the heat exchanger for moving load space air across the coils and for returning the air to the load space.

In addition, some embodiments of the invention provide a method for conditioning load space air with a temperature control system. The method can include the acts of operating the temperature control system in a cooling mode for cooling the load space air, a heating mode for heating load space air, and a defrost mode for defrosting an evaporator coil. The method can further include the act of directing a refrigerant, such as, for example, a cryogen or other heat transfer fluid through the evaporator coil and directing a different heat transfer fluid through a heating coil adjacent to the evaporator coil.

In one embodiment, the invention provides a temperature-controlled vehicle including a driving portion including an engine powering the vehicle for movement, a cargo portion including a load space, a heat exchanger in communication with the load space, a cryogen refrigeration circuit in communication with the heat exchanger, a fossil fuel heater selectively providing heat to the load space, a control system interactively coupled with the cryogen refrigeration circuit and the fossil fuel heater to control the temperature within the load space, and an electrical power supply disposed on the cargo portion and coupled to the fossil fuel heater and the control system to selectively provide electrical power thereto.

In another embodiment, the invention provides a temperature-controlled vehicle including a driving portion having an engine powering the vehicle for movement and an associated electrical system. The vehicle further includes a cargo portion having a load space, a heat exchanger in communication with the load space, a cryogen refrigeration circuit in communication with the heat exchanger, a control system interactively coupled with the cryogen refrigeration circuit to control the temperature within the load space, and a standalone electrical power supply disposed on the cargo portion. The control system is powered by the electrical system of the driving portion during a first condition, and the control system is powered by the standalone electrical power supply of the cargo portion during a second condition.

In yet another embodiment, the invention provides a temperature-controlled vehicle including a cargo portion having a load space, a cryogen refrigeration circuit in communication with the load space and operable to selectively cool the load space, an electric blower positioned inside the load space, a control system interactively coupled with the cryogen refrigeration circuit to control the temperature within the load space, a short-term power supply operable to provide electrical power to the electric blower and the control system during a first condition, and a long-term power supply separate from the short-term power supply and operable to provide power to the electric blower and the control system during a second condition.

Other aspects of the invention will become apparent by consideration of the detailed description and accompanying drawings.

### BRIEF DESCRIPTION OF THE DRAWINGS

FIG. 1 is a side view of a vehicle including a trailer having a temperature control system according to some embodiments of the present invention.

FIG. 2 is a schematic illustration of the temperature control system shown in FIG. 1.

FIG. 3A is a schematic representation of a refrigeration circuit of the temperature control system shown in FIG. 1.

FIG. 3B is a schematic representation of a heating circuit of the temperature control system shown in FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

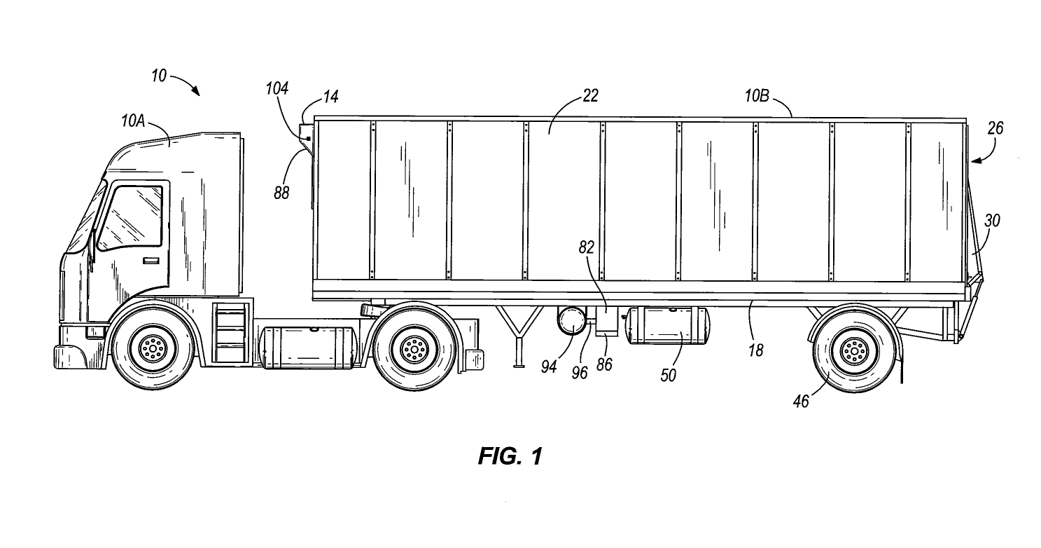

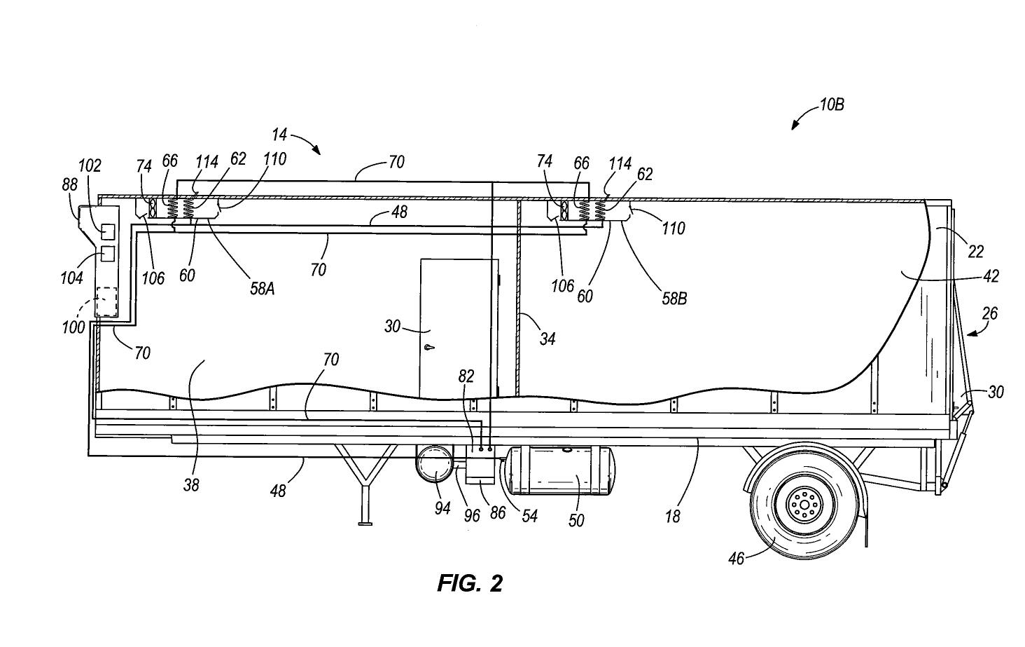

FIGS. 1 and 2 illustrate a vehicle 10 and a temperature control system 14 according to the present invention. As illustrated in FIG. 1, the vehicle 10 includes a road tractor 10A and a detachable cargo portion, such as a semi-trailer 10B (simply “trailer” hereinafter). In other embodiments, the vehicle 10 is a straight truck, van, or the like having an integral cargo portion, which is not readily separable from an associated driving portion.

As shown in FIG. 1, the trailer 10B includes a frame 18 and an outer wall 22 supported on the frame 18 and substantially enclosing a load space 26. Doors 30 are supported on the frame 18 for providing access to the load space 26. In some embodiments, the load space 26 can include a partition or an internal wall 34 (FIG. 2) for at least partially dividing the load space 26 into sub-compartments, including two or more load space zones 38, 42, each of which can be maintained at a different set point temperature, as described in greater detail below. A plurality of wheels 46 are provided on the frame 18 to permit movement of the vehicle 10 across the ground. In embodiments in which the vehicle 10 does not include a tractor 10A and a trailer 10B, the truck, container, etc. can include some or all of the features of the trailer 10B shown in the figures and described herein.

In the illustrated embodiment of FIGS. 1 and 2, the temperature control system 14 includes a cryogen storage tank 50 housing a quantity of a cryogen, such as, for example, nitrogen (N₂) or carbon dioxide (CO₂). In the illustrated embodiment, the cryogen storage tank 50 is supported on the frame 18 under the load space 26. In other embodiments, the cryogen storage tank 50 can be located in another location on the vehicle 10, such as, for example, in the trailer 10B (within or separately contained from the load space 26), on the outer wall 22 of the trailer 10B, in a nose cap 88 secured to a forward end of the trailer 10B, etc.

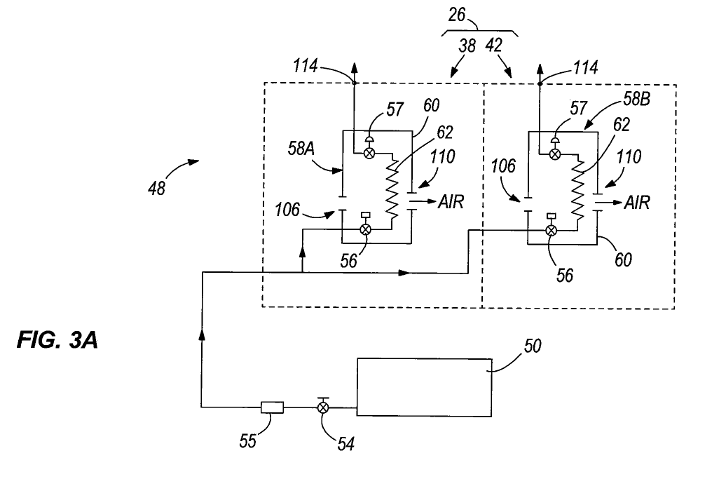

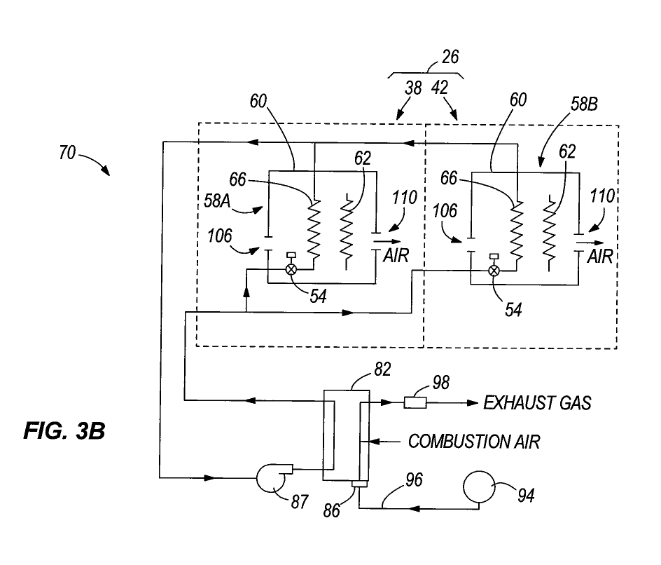

The temperature control system 14 includes a refrigeration circuit 48 extending outwardly from the cryogen storage tank 50. As shown in FIGS. 2 and 3A, the refrigeration circuit 48 includes a valve 54 for controlling and/or interrupting the flow of cryogen out of the cryogen storage tank 50 and through the refrigeration circuit 48. In the illustrated embodiment, the valve 54 is positioned immediately downstream from the cryogen storage tank 50. Downstream of the valve 54, a filter 55 (FIG. 3A) is positioned along the refrigeration circuit 48 to filter the cryogen as it flows out of the storage tank 50. In some embodiments, the valve 54 can be positioned in different locations (other than that shown in FIG. 3A) along the refrigeration circuit 48. In some embodiments, additional valves 56 and 57 are also positioned along the refrigeration circuit 48, as discussed in further detail below.

The temperature control system 14 also includes one or more heat exchangers 58. As illustrated in FIG. 2, the temperature control system 14 includes a first heat exchanger 58A positioned in the first load space zone 38 and a second heat exchanger 58B positioned in the second load space zone 42. In other embodiments, the temperature control system 14 can include one, three, or more heat exchangers 58 positioned in one, three, or more load space zones. In some embodiments, the heat exchangers 58 are mounted substantially external to the load space 26, but in heat exchange communication therewith.

In some embodiments, as illustrated in FIG. 2, the first and second heat exchangers 58A, 58B can be substantially similar. Accordingly, while the following description makes reference to elements of the first heat exchanger 58A, it should be understood that the second heat exchanger 58B can include identical or substantially similar structure. Alternately, the first and second heat exchangers 58A and 58B can be differently configured (e.g., differently configured to provide different heating/cooling capacities, etc.)

As shown in FIG. 2, the first heat exchanger 58A can include a housing 60, an evaporator coil 62 and a heating coil 66. Each of the coils 62, 66 extends through the heat exchanger housing 60. The evaporator coil 62 is fluidly connected to and positioned along the refrigeration circuit 48 and the heating coil 66 is fluidly connected to and positioned along a heating circuit 70 (partially shown in FIG. 2).

As shown in FIG. 2, the refrigeration circuit 48 and the cryogen conveyed through the refrigeration circuit 48 are maintained separately from the heating circuit 70 and the heat transfer fluid (e.g., glycol/water mixture) conveyed through the heating circuit 70 so that the cryogen and the heat transfer fluid are not mixed.

In some embodiments, two or more valves can be used to control and/or limit fluid flow through the refrigeration circuit 48. In some embodiments, as shown in FIG. 3A, a flow control valve 56 is located upstream of each evaporator coil 62 to control the flow of cryogen through the evaporator coils 62. FIG. 3 also illustrates a back pressure regulator valve 57 located downstream of each of the evaporator coils 62 to prevent the formation of dry ice (if the cryogen is CO₂). In some embodiments, an electronically-controlled valve may be placed downstream of each evaporator coil 62 to precisely control the flow of cryogen and eliminate the need for the upstream flow control valve 56 and the back pressure regulator valve 57 in combination.

The housing 60 includes an air inlet 106 and an air outlet 110 for receiving air from and returning air to the load space 26, respectively. The housing 60 also supports a fan or blower 74 for drawing load space air into the heat exchanger housing 60 through the air inlet 106, moving the load space air across the coils 62, 66, and returning the load space air to the load space 26 through the air outlet 110.

As shown in FIGS. 2 and 3B, the temperature control system 14 includes a heating element 82, such as, for example, a diesel-fired heating element. In the illustrated embodiment, the heating element is an Espar Hydronic model 5™. The heating element 82 also includes one or more atomizers 86 for controlling and distributing fuel supplied to the heating element 82. A pump 87 pumps heat transfer fluid through the heating circuit 70. The heat transfer fluid is heated in the heating element 82 and then it is pumped to at least one of the heat exchangers 58A and 58B, where the heat is then transferred to the load space 26.

The heating element 82 is supported on the frame 18 under the load space 26. In other embodiments, the heating element 82 and/or the atomizer 86 can be located in another location on the vehicle 10, such as, for example, in the trailer 10B (within or separately contained from the load space 26), on the outer wall 22 of the trailer 10B, and the like. In still other embodiments, the heating element 82 and/or the atomizer 86 can be located in the nose cap or power box 88, which is secured to a forward end of the outer wall 22.

As illustrated in FIGS. 1, 2, and 3B, and provided that the heating element 82 is diesel-fired, the temperature control system 14 can include a fuel storage tank 94. In some embodiments, other heating elements 82, utilizing other fuels, and other fuel storage tanks 94 housing fuels for such other heating elements 82 can also or alternately be used.

As shown in FIGS. 1 and 2, the fuel storage tank 94 is supported on the frame 18 under the load space 26. In some embodiments, the fuel storage tank 94 can be located in another location on the vehicle 10, such as, for example, in the nose cap 88, in the trailer 10B (within or separately contained from the load space 26), on the outer wall 22 of the trailer 10B, and the like. The temperature control system 14 also includes a fuel line 96 extending between the fuel storage tank 94 and the heating element 82. Fuel is supplied to the heating element 82 and combined with air for combustion. Exhaust gases of the combustion are exhausted from the heating element 82 through a muffler 98 to the atmosphere.

The temperature control system 14 also includes a dedicated power source 100, such as, for example, a battery, a fuel cell, a fossil fuel powered generator set, and the like, for supplying power to the fans 74, a controller 102, and other power-consuming elements. The dedicated power source 100 is mounted to and dedicated to the trailer 10B. In some embodiments, the dedicated power source 100 includes a deep cycle battery pack supported in the nose cap 88. In other embodiments, the dedicated power source(s) 100 can be located in another location on the vehicle 10, such as, for example, on the frame 18 under the load space 26, in the load space 26, on the outer wall 22 of the trailer 10B, and the like.

As illustrated in FIG. 2, the temperature control system 14 can also include an electrical input or receptacle 104 for receiving power from one or more external power sources (external to the trailer 10B, and in some cases external to the vehicle 10). In some embodiments, an engine or a battery of the tractor 10A powering the vehicle 10 can supply electrical power to the fans 74, a controller 102, and/or other power-consuming elements of the temperature control system 14. Alternately or in addition, the receptacle 104 can be configured for receiving power from a land-based power network (e.g., an AC power outlet available at a truck depot) for supplying electrical power to the fans 74, a controller 102, and/or other power-consuming elements of the temperature control system 14. Alternately or in addition, the receptacle 104 can be configured to receive DC electrical power from an external power source.

In some embodiments, the temperature control unit 14 can also include an adapter (not shown) to facilitate an electrical connection between the receptacle 104 and various standard external power sources. For example, the adapter can be engageable with a 120 V AC circuit and/or with a 230 V AC circuit and/or with 12 V or 24 V DC sources. In other embodiments, the temperature control unit 14 can include a plurality of separate receptacles 104 for engaging various standard or non-standard external power sources.

In embodiments, such as the illustrated embodiment of FIGS. 1 and 2, having a dedicated power source 100, an external power source (e.g., an engine or a battery of the tractor 10A, a land-based power network, etc.) can supply power to the fans 74, the controller 102, and/or other power-consuming elements of the temperature control system 14 during normal operation of the temperature control system 14 (e.g., when the vehicle 10 is connected to the tractor 10A or when the vehicle 10 is parked at a depot having a land-based power network). In some such embodiments, the dedicated power source 100 can supply power to the fans 74, the controller 102, and/or other power-consuming elements of the temperature control system 14 when the vehicle 10 is not connected to the tractor 10A and/or when the vehicle 10 is parked in a location not having an available land-based power network or other external electrical power source.

In some embodiments, a relatively small amount of power (e.g., about 1 kW) is required to operate the fans 74, the controller 102, and/or other power-consuming elements of the temperature control system 14. In these embodiments, the dedicated power source 100 can supply power to the fans 74, the controller 102, and/or other power-consuming elements of the temperature control system 14 for an extended period of time (e.g., at least about 4 hours). In some such embodiments, the dedicated power source 100 can also or alternately supply power for operating accessories, such as, for example, motors that operate lift gates and/or open and close the vehicle door 30.

As described above, the temperature control system 14 can be selectively powered by one or more intermittent power sources (electrical system of tractor 10A, battery, etc.) and one or more long-term power sources (land-based power network providing AC or DC power, fossil fuel powered generator set, etc.). The temperature control system 14 is configured to draw power from at least two different power sources depending upon the usage of the vehicle 10. For example, the temperature control system 14 can draw power from an intermittent power source during over-the-road travel. During short periodic times of non-use (parking during deliveries, etc.), the temperature control system 14 can continue to draw power from an intermittent power source or be switched over to draw power from a long-term, or “extended use”, power source, which does not drain the intermittent power source (and may be used to recharge the intermittent power source). Therefore, the temperature control system 14 is equipped to operate on various power sources dependent upon the usage condition of the vehicle 10.

In some embodiments, the controller 102 can operate the temperature control system 14 in a cooling mode, a heating mode, and a defrost mode to maintain or achieve a desired set point temperature in the load space zones 38, 42. Each load space zone 38, 42 can independently maintain and achieve a different set point temperature. For example, the first load space zone 38 can be in a cooling mode while the second load space zone 42 is in a heating mode or a defrost mode.

During operation of the temperature control system 14 in the cooling mode (shown schematically in FIG. 3A), cryogen is directed through the refrigeration circuit 48 to the evaporator coil 62 of the first heat exchanger 58A and/or the evaporator coil 62 of the second heat exchanger 58B. The fan 74 draws load space air into the heat exchanger housing 60 through the inlet 106, directs the load space air across the evaporator coil 62 to cool the load space air, and returns the cooled load space air to the load space 26 through the air outlet 110. As the cryogen travels through the evaporator coil 62, the cryogen is vaporized. The vaporized cryogen from each heat exchanger 58A, 58B is then vented to the atmosphere through respective vents 114.

During operation in the heating mode (shown schematically in FIG. 3B), the heating element 82 heats the heat transfer fluid in the heating circuit 70. The heated fluid is then pumped by the pump 87 through the heating circuit 70 to the heating coil 66 of the first heat exchanger 58A and/or the second heat exchanger 58B. The fan 74 then draws load space air into the heat exchanger housing 60 through the inlet 106, directs the load space air across the heating coil 66 to warm the load space air, and returns the warmed load space air to the load space 26 through the air outlet 110. The heat transfer fluid is then cycled back through the heating circuit 70 to be reheated by the heating element 82

In some embodiments, the controller 102 can prevent cryogen from moving through the refrigeration circuit 48 from the cryogen storage tank 50 to the evaporator coils 62 when the temperature control system 14 is operating in the heating mode and/or the defrost mode. In some such embodiments, one or more of the valves 54 are closed during operation of the temperature control system 14 in a heating and/or defrost mode.

During operation in defrost mode, the air inlet 106 and/or the air outlet 110 of each heat exchanger 58A, 58B are partially or completely closed (e.g., by doors or flaps) and/or the fans 74 are shut down to limit the transfer of heat from the first heat exchanger 58A and/or the second heat exchanger 58B to the load space 26. Alternately, the fan speed can be lowered during the defrost mode. The heating element 82 then heats the heat transfer fluid in the heating circuit 70. The heated fluid is then pumped through the heating circuit 70 to the heating coil 66 of the first heat exchanger 58A and/or the second heat exchanger 58B. Heat radiating from the heating coil 66 then defrosts and/or thaws the adjacent evaporator coil 62 in the first heat exchanger 58A and/or the second heat exchanger 58B.

The controller 102 can be programmed to initiate operation of the refrigeration system 14 in the defrost mode based upon a sensed condition (e.g., a pressure change of air flowing across the evaporator coils 62, a temperature change in the heat exchanger housing 60, and the like), or alternatively, the defrost mode can be initiated at pre-determined times (e.g., every 4 hours). Each heat exchanger 58A, 58B can be independently defrosted based upon different sensed conditions and/or pre-determined times.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

What is claimed is:

1. A temperature-controlled vehicle comprising:
a driving portion including an engine powering the vehicle for movement;
a cargo portion including a load space;
a heat exchanger in communication with the load space;
a cryogen refrigeration circuit in communication with the heat exchanger;
a fossil fuel heater selectively providing heat to the load space;
a control system interactively coupled with the cryogen refrigeration circuit and the fossil fuel heater to control the temperature within the load space; and
an electrical power supply disposed on the cargo portion and coupled to the fossil fuel heater and the control system to selectively provide electrical power thereto.

2. The temperature-controlled vehicle of claim 1, further comprising an electric blower positioned inside the load space to move air across the heat exchanger, the electric blower being powered by the electrical power supply of the cargo portion.

3. The temperature-controlled vehicle of claim 1, wherein the cargo portion is separable from the driving portion.

4. The temperature-controlled vehicle of claim 3, wherein the cryogen refrigeration circuit and the fossil fuel heater are disposed on the cargo portion and are operable to control the temperature of the load space when the cargo portion is de-coupled from the driving portion.

5. The temperature-controlled vehicle of claim 1, wherein the electrical power supply of the cargo portion includes a fossil fuel powered generator set.

6. The temperature-controlled vehicle of claim 5, wherein the fossil fuel powered generator set provides electrical power to open and close at least one door of the cargo portion.

7. The temperature-controlled vehicle of claim 1, wherein the electrical power supply of the cargo portion includes at least one of a deep cycle battery and a fuel cell.

8. A temperature-controlled vehicle comprising:
a driving portion including an engine powering the vehicle for movement and an associated electrical system;
a cargo portion including a load space;
a heat exchanger in communication with the load space;
a cryogen refrigeration circuit in communication with the heat exchanger;
a control system interactively coupled with the cryogen refrigeration circuit to control the temperature within the load space; and
a standalone electrical power supply disposed on the cargo portion, wherein the control system is powered by the electrical system of the driving portion during a first condition, and the control system is powered by the standalone electrical power supply of the cargo portion during a second condition.

9. The temperature-controlled vehicle of claim 8, wherein the cargo portion is separable from the driving portion.

10. The temperature-controlled vehicle of claim 9, further comprising a diesel heater, the diesel heater being operable to selectively heat the load space.

11. The temperature-controlled vehicle of claim 10, wherein the cryogen refrigeration circuit and the diesel heater are disposed on the cargo portion and are operable to control the temperature of the load space when the cargo portion is de-coupled from the driving portion.

12. The temperature-controlled vehicle of claim 8, wherein the standalone electrical power supply of the cargo portion includes a fossil fuel powered generator set.

13. The temperature-controlled vehicle of claim 12, wherein the fossil fuel powered generator set provides electrical power to open and close at least one door of the cargo portion.

14. The temperature-controlled vehicle of claim 8, wherein the standalone electrical power supply of the cargo portion includes at least one of a deep cycle battery and a fuel cell.

15. The temperature-controlled vehicle of claim 8, further comprising an electrical input associated with the cargo portion, the electrical input configured to receive electrical power from a source external to the temperature-controlled vehicle to power the control system during a third condition.

16. A temperature-controlled vehicle comprising:
a cargo portion including a load space;
a cryogen refrigeration circuit in communication with the load space and operable to selectively cool the load space;
an electric blower positioned inside the load space;
a control system interactively coupled with the cryogen refrigeration circuit to control the temperature within the load space;
an intermittent power supply operable to provide electrical power to the electric blower and the control system during a first condition; and
a long-term power supply separate from the intermittent power supply and operable to provide power to the electric blower and the control system during a second condition.

17. The temperature-controlled vehicle of claim 16, further comprising a driving portion having an associated electrical system, wherein the intermittent power supply includes the electrical system of the driving portion.

18. The temperature-controlled vehicle of claim 16, wherein the intermittent power supply includes a deep cycle battery.

19. The temperature-controlled vehicle of claim 16, wherein the long-term power supply includes an electrical input associated with the cargo portion and operable to receive electrical power from a source external to the cargo portion.

20. The temperature-controlled vehicle of claim 16, wherein the long-term power supply includes a fossil fuel powered generator set disposed on the cargo portion.
